(19) United States
(12) Patent Application Publication
(10) Pub. No.: US 2026/0312123 A1
(43) Pub. Date: Oct. 8, 2026

(54) ELECTROLYTE FOR A LITHIUM METAL BATTERY AND A LITHIUM METAL BATTERY INCLUDING THE SAME

(71) Applicants: HYUNDAI MOTOR COMPANY, Seoul (KR); KIA CORPORATION, Seoul (KR)

(72) Inventors: Yeonjong Oh, Hwaseong-si (KR); Ji Yong Lee, Hwaseong-si (KR); Sangheon Lee, Hwaseong-si (KR); Eunji Kwon, Hwaseong-si (KR); Kyuju Kwak, Hwaseong-si (KR); Jiho Lim, Hwaseong-si (KR); Dong Hyun Lee, Hwaseong-si (KR); Sangsu Lee, Hwaseong-si (KR); Kyoung Han Ryu, Hwaseong-si (KR); Samuel Seo, Hwaseong-si (KR)

(73) Assignees: HYUNDAI MOTOR COMPANY, Seoul (KR); KIA CORPORATION, Seoul (KR)

(21) Appl. No.: 19/313,367

(22) Filed: Aug. 28, 2025

(30) Foreign Application Priority Data
Apr. 3, 2025 (KR) 10-2025-0043333

(51) Int. Cl. H01M 10/056; H01M 4/02; H01M 4/525; H01M 10/0525; H01M 50/409

(52) U.S. Cl. CPC H01M 10/056; H01M 4/525; H01M 10/0525; H01M 50/409; H01M 2004/028; H01M 2300/0034; H01M 2300/0091

(57) ABSTRACT

An electrolyte for a lithium metal battery includes a lithium salt, a non-aqueous organic solvent, and an additive. The additive includes a compound represented by Chemical Formula 1: R¹—O—R². In Chemical Formula 1, R¹ is a substituted or unsubstituted C1 to C20 alkyl group, and R² is represented by Chemical Formula 2:

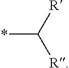

In Chemical Formula 2, R′ and R″ are each independently a substituted or unsubstituted C1 to C20 alkyl group, and * represents a moiety linked to one or more same or different atoms or chemical formulas. R¹ and R² are different from each other.

### CROSS-REFERENCE TO RELATED APPLICATION

This application claims priority to and the benefit of Korean Patent Application No. 10-2025-0043333 filed with the Korean Intellectual Property Office on Apr. 3, 2025, the entire contents of which are incorporated herein by reference.

### TECHNICAL FIELD

The present disclosure relates to an electrolyte for a lithium metal battery and a lithium metal battery including the same.

### BACKGROUND

As the electric vehicle market grows, there is an increasing need for high-capacity batteries that surpass lithium ion batteries and, accordingly, an increasing demand for negative and positive electrode materials with high energy density and long-term stability of the lithium metal batteries.

Lithium metal, which has high capacity per weight of 3,860 mAh/g and a low standard electrode potential (i.e., −3.04 V vs normal or standard hydrogen electrode), is attracting attention as a negative electrode material for rechargeable lithium batteries. However, the lithium metal is highly reactive, creating an extremely reducing atmosphere during the charging process, which may cause an irreversible decomposition reaction between the lithium metal and an electrolyte. The decomposition reaction may deplete the electrolyte, and the decomposition products may form a nonuniform film on the lithium metal surface. In addition, the lithium grows in the form of dendrites, as charging and discharging are repeated. The dendritic lithium causes electrical short circuits inside the batteries, leading to safety issues such as fires of the batteries and the like.

### SUMMARY

In view of the foregoing, to apply lithium metal with high stability and high capacity, it is necessary to develop an electrolyte that alleviates reactivity of lithium metal, prevents dendritic lithium growth, and enables uniform lithium electrodeposition (plating).

An aspect is to provide an electrolyte for a lithium metal battery which may assist a function of an N,N-dimethylsulfamoyl fluoride solvent that forms a negative electrode film, while significantly improving durability and electrochemical characteristics of the lithium metal battery.

An electrolyte for a lithium metal battery according to an embodiment includes a lithium salt, a non-aqueous organic solvent, and an additive including a compound represented by Chemical Formula 1:

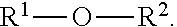

In Chemical Formula 1, R¹ is a substituted or unsubstituted C1 to C20 alkyl group, and R² is represented by Chemical Formula 2:

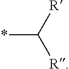

In Chemical Formula 2, R′ and R″ are each independently a substituted or unsubstituted C1 to C20 alkyl group, and * represents a moiety linked to one or more same or different atoms or chemical formulas.

In Chemical Formula 1, R¹ and R² are different from each other.

In Chemical Formula 1, R¹ may be an unsubstituted C1 to C10 alkyl group.

The non-aqueous organic solvent may include N,N-dimethylsulfamoyl fluoride.

The non-aqueous organic solvent may further include a viscosity-reducing agent.

The viscosity-reducing agent may include a compound represented by Chemical Formula 3:

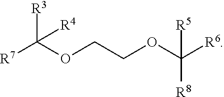

In Chemical Formula 3, R³ to R⁶ may each independently be a halogen group, and R⁷ and R⁸ may each independently be a C1 to C20 alkyl group substituted or unsubstituted with one or more halogen groups.

The additive including the compound represented by Chemical Formula 1 may be included in an amount of “greater than 1.0 wt % and less than or equal to 2.0 wt %” or “1.5 wt % to 2.0 wt %” based on a total amount (100 wt %) of the electrolyte for the lithium metal battery.

The lithium salt may include at least one of lithium bis(fluorosulfonyl)imide (LiFSI), lithium (fluorosulfonyl)(nonafluorobutanesulfonyl)imide (LiFNFSI), or lithium bis(trifluoromethanesulfonyl)imide (LiTFSI).

A concentration of the above lithium salt may be in a range of 1.0 M to 4.0 M.

According to another embodiment of the present disclosure, a lithium metal battery may include: a positive electrode; a lithium metal layer as a negative electrode facing the positive electrode; a separator interposed between the positive electrode and the negative electrode; and an electrolyte for the lithium metal battery.

The electrolyte for the lithium metal battery may be an electrolyte according to an embodiment of the present disclosure.

The lithium metal layer may have a thickness in a range of 5 μm to 50 μm.

The positive electrode may include a lithium-nickel-manganese-cobalt-based metal oxide.

### BRIEF DESCRIPTION OF THE DRAWINGS

FIG. 1 is a capacity-charge-discharge graph for evaluating the durability of the lithium metal battery cells (coin cells) including electrolytes according to Example 1, Comparative Example 1, and Comparative Example 2.

FIG. 2 is a capacity-charge-discharge graph for evaluating the durability of the lithium metal battery cells (coin cells) including electrolytes according to Example 2 and Comparative Example 3.

FIG. 3 is a scanning electron microscope (SEM) photograph taken to analyze the morphology of lithium electrodeposited on the upper portion of the lithium negative electrode after 10 charge/discharge cycles of the lithium metal battery cell (coin cell) including the electrolyte according to Comparative Example 1.

FIG. 4 is a scanning electron microscope (SEM) photograph taken to analyze the morphology of lithium electrodeposited on the upper portion of the lithium negative electrode after 10 charge/discharge cycles of the lithium metal battery cell (coin cell) including the electrolyte according to Comparative Example 2.

FIG. 5 is a scanning electron microscope (SEM) photograph taken to analyze the morphology of lithium electrodeposited on the upper portion of the lithium negative electrode after 10 charge/discharge cycles of the lithium metal battery cell (coin cell) including the electrolyte according to Example 1.

FIGS. 6 and 7 are Raman analysis data for the analysis of the solvation structures between Li⁺ and FSI⁻ and between FSI⁻ and non-aqueous organic solvents (Li⁺↔FSI⁻↔non-aqueous organic solvents) for each electrolyte according to Example 1, Comparative Example 1, and Comparative Example 2, respectively.

FIG. 8 is nuclear magnetic resonance (NMR) analysis data quantitatively analyzing the amount of lithium salt consumed according to the operation of lithium metal battery cells including the electrolytes according to Example 1, Comparative Example 1, and Comparative Example 2.

FIG. 9 is a capacity-charge-discharge graph for evaluating the durability of the lithium metal battery cells (coin cells) including electrolytes according to Example 1 and Examples 3-8.

FIG. 10 is a graph showing the ionic conductivity of each electrolyte according to Example 1, Comparative Example 1, and Comparative Example 2.

FIG. 11 is a graph showing the ionic conductivity of each electrolyte according to Example 1 and Examples 3-8.

### DETAILED DESCRIPTION

In the present disclosure, terms such as “first,” “second,” “third,” and the like are used for describing various arts, components, regions, layers, and/or sections, but are not limited thereto. These terms are only used to distinguish any part, component, region, layer, or section from the other part, component, region, layer, or section. Accordingly, the first part, component, region, layer, or section described below may be mentioned as the second part, component, region, layer, or section within the range without departing from the range of the present disclosure.

Special terms used herein is for the purpose of describing embodiments only and are not intended to be limiting of the present disclosure. The singular forms used herein include plural forms as well, if the phrases do not clearly have the opposite meaning. The term “including,” “having,” “comprising” or the like used in the specification means that a specific feature, region, integer, step, operation, element and/or component is embodied and other specific features, regions, integers, steps, operations, elements, and/or components are not excluded.

When any part of or referred to as being “on”, “over” the other part, which might be directly on or over the other parts or may be a different part involves therebetween. On the contrary, when any part is mentioned as being “directly on” the other parts, the other part is not interposed therebetween.

Unless defined otherwise, all terms including technical and scientific terms used herein have the same meaning as commonly understood by those having ordinary skill in the art to which the present disclosure belongs. Commonly used predefined terms are further interpreted as having a meaning consistent with the relevant technical literature and the present disclosure, and are not to be construed as ideal or very formal meanings unless defined otherwise.

As used herein, the term “combination(s) thereof” described in the expression in the Markush format refers to one or more mixtures or combinations selected from the components described in the expression in the Markush format, and refers to including at least one selected from the components. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Additionally, as used herein, when specific definition is not otherwise provided, “*” means a moiety that is linked to the same or different atoms or chemical formulas.

Further, as used herein, “Li-NCM” may refer to a lithium secondary battery (or lithium metal battery) that uses a cathode active material containing Ni, Co, and Mn.

Hereinafter, the present disclosure is described more fully hereinafter, in which embodiments of the present disclosure are shown. As those having ordinary skill in the art should realize, described embodiments may be modified in various different ways, all without departing from the spirit or scope of the present disclosure.

### Electrolyte for Lithium Metal Battery

In a lithium metal battery, an N,N-dimethylsulfamoyl fluoride (DMSF or FSA)-based electrolyte suffer from continuous oxidation and reduction decomposition. Therefore, there is a need for an additive composition that helps form solid electrolyte interphase (SEI) (negative electrode film) to minimize the reaction between the electrolyte and the electrode. In fact, various additives are being developed to delay deterioration, and the present disclosure relates to a novel structural electrolyte additive for a lithium metal battery that can achieve high durability performance improvement.

Generally, N,N-dimethylsulfamoyl fluoride (DMSF or FSA) is widely used as an electrolyte for a lithium metal battery to form a negative electrode stable film. In this example, a composition using TTE (1,1,2,2-tetrafluoroethyl 2,2,3,3-tetrafluoropropyl ether), a fluorinated solvent with a symmetrical structure, as an ether-based electrolyte additive is known. There is an evaluation that this compensates for disadvantages of high-concentration electrolytes by lowering the viscosity of the electrolyte with low viscosity characteristics while maintaining the solvation structure of the electrolyte with very low lithium salt solubility due to a large amount of —F functional groups (where F is fluorine). However, the problem of durability deterioration due to low electrochemical stability of the electrolyte has not been solved. An aspect of the present disclosure provides a novel, asymmetrically structured fluorinated additive that has never been proposed before. According to an aspect of the present disclosure, the novel, asymmetrically structured fluorinated additive is employed in an N,N-dimethylsulfamoyl fluoride (hereinafter, DMSF or FSA) series electrolyte-based lithium metal battery, thereby simultaneously realizing the effect of reducing viscosity and improving durability.

The present disclosure provides an electrolyte composition that can delay electrolyte decomposition and contribute to improving the durability of a lithium metal battery by adding a novel asymmetrically structured fluorinated additive, and is advantageous when added to not only DMSF series electrolytes but also other fluorinated solvent series electrolytes.

An electrolyte for a lithium metal battery according to an embodiment may include a lithium salt, a non-aqueous organic solvent, and an additive including a compound represented by Chemical Formula 1:

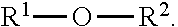

In Chemical Formula 1, R¹ is a substituted or unsubstituted C1 to C20 alkyl group, and R² is represented by Chemical Formula 2:

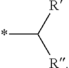

In Chemical Formula 1, R¹ and R² are different from each other.

In Chemical Formula 2, R′ and R″ are each independently a substituted or unsubstituted C1 to C20 alkyl group, and * represents a moiety linked to one or more same or different atoms or chemical formulas.

In Chemical Formula 2, R′ and R″ are each independently trifluoromethyl group.

Looking at the structure of the compound represented by Chemical Formula 1, R¹ and R² substituents are positioned on both sides of the *—O—CH₂—* linking group. As described above, since R¹ and R² are different from each other, the compound represented by Chemical Formula 1 has an asymmetric structure.

In other words, in Chemical Formula 1, R¹ is not represented by Chemical Formula 2.

For example, in Chemical Formula 1, R¹ may be an unsubstituted C1 to C10 alkyl group. In this example, the improvement in durability performance of a lithium metal battery according to an embodiment may be maximized or improved.

The additive including the compound represented by Chemical Formula 1 may be included in an amount of more than 0.1 wt % and less than or equal to 2.0 wt % based on a total amount (100 wt %) of the electrolyte for a lithium metal battery. By controlling the amount of the additive as described above, the SEI film is formed neither too thin nor too thick, and there is no change in the inherent solvation structure of the electrolyte due to the additive, so that the durability characteristics of a lithium metal battery including the same may be significantly improved.

The additive including the compound represented by Chemical Formula 1 may be included in an amount of 0.5 wt % to 2.0 wt %, for example, 1.5 wt % to 2.0 wt %, or, in another example, 1.5 wt %, based on the total amount (100 wt %) of the electrolyte for a lithium metal battery. When an electrolyte (for example, an electrolyte in which a viscosity-reducing agent described below is not added to a non-aqueous organic solvent) is composed of an additive including the compound represented by Chemical Formula 1 within the above range, cycle-life characteristics of a lithium metal battery including a lithium metal negative electrode may be improved and a very stable coulombic efficiency may be exhibited.

The non-aqueous organic solvent may include N,N-dimethylsulfamoyl fluoride (DMSF or FSA). These types of non-aqueous organic solvents have high compatibility with a lithium metal negative electrode and excellent compatibility with a lithium salt including a fluorosulfonyl group. Therefore, when an electrolyte is synthesized using this as a solvent with a composition according to an embodiment, the SEI interface characteristics of lithium metal may be improved and durability performance may be significantly improved.

The non-aqueous organic solvent may additionally include an ether-based solvent in addition to the above types, or an ether-based solvent may be used alone as the non-aqueous organic solvent. The ether-based solvent may include dipropyl ether, dimethoxy ether, diethyl ether, 1,2-diethoxyethane, cyclopentyl methyl ether, methyl propyl ether, n-butyl methyl ether, ethyl propyl ether, dimethoxymethane, 1,4-dioxane, 1,2,2-tetrafluoroethyl-2,2,3,3-tetrafluoropropyl ether, or a combination thereof.

The non-aqueous organic solvent may further include a viscosity-reducing agent having a viscosity reducing effect.

For example, the viscosity-reducing agent may include a compound represented by Chemical Formula 3:

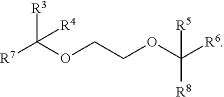

In Chemical Formula 3, R³ to R⁶ are each independently a halogen group, and R⁷ and R⁸ are each independently a C1 to C20 alkyl group substituted or unsubstituted with one or more halogen groups.

For example, in R³ to R⁸, the halogen group may be a fluoro group (*—F).

For example, the compound represented by Chemical Formula 3 may be represented by Chemical Formula 3-1:

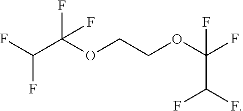 [SMILES: FC(F)C(F)(F)OCCOC(F)(F)C(F)F]

Electrolytes for lithium metal batteries developed to date have high viscosity due to their compositions in which high-concentration salts are dissociated. Thus, it is needed to apply a viscosity-reducing agent to improve the low wettability of the electrolyte at the positive electrode. From repeated research on the structure of an appropriate viscosity-reducing agent, the present disclosure has confirmed that when a viscosity-reducing agent having a structure represented by Chemical Formula 3, specifically Chemical Formula 3-1, is used, the viscosity of the electrolyte may be lowered while also improving the durability of the lithium metal battery.

For example, when the viscosity-reducing agent is included in the non-aqueous organic solvent in the electrolyte for a lithium metal battery according to an embodiment, it may be advantageous to include the additive including the compound represented by Chemical Formula 1 in an amount of 1.5 wt % to 2.0 wt %, for example, 2.0 wt %, based on the total amount (100 wt %) of the electrolyte for a lithium metal battery, in order to lower the viscosity of the electrolyte while maximizing the durability performance of the lithium metal battery.

According to an embodiment, the lithium salt may include at least one of lithium bis(fluorosulfonyl)imide (LiFSI), lithium (fluorosulfonyl)(nonafluorobutanesulfonyl)imide (LiFNFSI), lithium bis(perfluoroethylsulfonyl)imide (LiBETI), or lithium bis(trifluoromethanesulfonyl)imide (LiTFSI), and for example, may be LiFSI.

A concentration of the lithium salt included in the electrolyte for a lithium metal battery according to an embodiment may be 1.0 M to 4.0 M, and for example, 1.0 M to 3.5 M, 1.0 M to 3.0 M, 1.0 M to 2.5 M, 1.0 M to 2.0 M, or 1.0 M to 1.5 M.

If the concentration of the lithium salt is below the above ranges, the conductivity of the electrolyte may decrease, which may result in poor electrolyte performance, and if the concentration of the lithium salt exceeds the above ranges, the viscosity of the electrolyte may increase, which may result in reduced mobility of lithium ions and a problem of overvoltage occurring from the beginning of the cycle. In addition, it is not advantageous that the SEI layer formed on the surface of the lithium metal, which is the negative electrode, is not formed at all or that a film that is too thick is formed, which may lower the electrochemical performance of the lithium metal battery.

### Lithium Metal Battery

Another embodiment provides a lithium metal battery including the electrolyte for a lithium metal battery as described above.

The lithium metal battery may include a positive electrode, a lithium metal layer as a negative electrode facing the positive electrode, a separator interposed between the positive electrode and the negative electrode, and the electrolyte for a lithium metal battery.

The negative electrode for a lithium metal battery may be a lithium metal layer, and the lithium metal layer itself may be used as a negative electrode for a battery.

A battery including the negative electrode may allow lithium ions from the positive electrode to move to the negative electrode to form a lithium metal layer when charged. Charging and discharging of the battery may be proceeded by forming or removing this lithium metal layer.

The negative electrode may be formed or provided on a negative electrode current collector such as copper.

The lithium metal layer may be formed on the negative electrode current collector by the formation charging and discharging of the lithium metal battery.

The lithium metal layer may have a thickness of 5 μm to 50 μm, for example, 10 μm to 50 μm, or may be formed to have the above thickness.

When the lithium metal layer satisfies the above thickness, side reactions between the lithium metal layer and the electrolyte may be suppressed, thereby improving the electrochemical performance of the lithium metal battery.

In another embodiment, the positive electrode is disposed opposite the negative electrode.

The positive electrode may include a positive electrode current collector and a positive electrode active material layer formed on the positive electrode current collector.

The positive electrode collector may be made of stainless steel, aluminum, nickel, titanium, calcined carbon, or aluminum or stainless steel surface-treated with carbon, nickel, titanium, silver, and the like.

The thickness of the positive electrode collector may be 3 μm to 500 μm.

The positive electrode active material layer includes a positive electrode active material.

The positive electrode active material may be a compound being capable of intercalating and deintercalating (i.e., intercalation and deintercalation of) lithium, and specifically may include lithium iron phosphate. When the positive electrode active material contains lithium iron phosphate, the compatibility with the electrolyte is the best or significantly improved, so that the effect of improving battery performance may be maximized or enhanced.

The positive electrode active material may include a lithium metal oxide which is a compound being capable of intercalating and deintercalating lithium, and for example, a lithium metal oxide including at least one of cobalt, manganese, nickel, or aluminum. For instance, the lithium metal oxide may include at least one of a lithium-manganese-based oxide, a lithium-cobalt-based oxide, a lithium-nickel-based oxide, a lithium-nickel-manganese-based oxide, a lithium-nickel-cobalt-based oxide, a lithium-manganese-cobalt-based oxide, a lithium-nickel-manganese-cobalt-based oxide, a lithium-manganese-cobalt-based oxide, or a lithium-nickel-cobalt-transition metal (M) oxide.

The positive electrode active material may be a lithium-nickel-manganese-cobalt-based oxide that may improve the capacity characteristics and stability of the battery. The positive electrode active material may be represented by Chemical Formula 4:

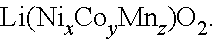

In Chemical Formula 4, Li is lithium, Ni is nickel, Co is cobalt, Mn is Manganese, and O is oxygen; and 0≤x≤1, 0≤y≤1, 0≤z≤1, and x+y+z=1.

For example, in Chemical Formula 4, 0.8≤x≤1, 0≤y≤1, 0≤z≤1, and x+y+z=1.

For example, in Chemical Formula 4, 0.89≤x≤1, 0≤y≤1, 0≤z≤1, and x+y+z=1.

In other words, the positive electrode may include a positive electrode active material including a lithium-nickel-manganese-cobalt-based metal oxide.

The positive electrode active material layer may further include a binder and/or a conductive material.

The separator separates the negative electrode and the positive electrode and provides a passage for lithium ions to move and is not limited as long as it is a separator commonly used in rechargeable lithium batteries.

The following examples illustrate the present disclosure in more detail. However, the following examples are only embodiments of the present disclosure, and the present disclosure is not limited to the following examples.

### Example—Preparation of Electrolyte for Lithium Metal Battery

After forming an electrolyte by adding 1 M of LiFSI salt to an FSA solvent and dissociating it, to the electrolyte from which moisture was removed, an additive also was added in an amount obtained by using a weight ratio and dissociated. Subsequently, calcium hydride (CaH₂) was added thereto in an amount of 1% or more of a total weight of a sample and removed after 30 minutes to finally prepare an electrolyte for a lithium metal battery. Each electrolyte of Example 2 and Comparative Example 3 was prepared by using, instead of the FSA solvent above, an FSA solvent including a viscosity-reducing agent represented by Chemical Formula 3-1.

Table 1 shows compositions of the electrolytes for lithium metal batteries according to the examples and the comparative examples.

In Table 1, an amount of the additive was based on a total amount of each electrolyte.

TABLE 1

| | Lithium | | |
|---|---|---|---|
| | salt | | |
| | (mole) | Solvent (mole) | Additive (wt %) |
| Example 1 | LiFSI(1) | FSA (3) | Chemical Formula E-1 (1.5) |
| Example 2 | LiFSI(1) | FSA/Chemical | Chemical Formula E-1 (2.0) |
| | | Formula 3-1 | |
| | | (3) | |
| Example 3 | LiFSI(1) | FSA (3) | Chemical Formula E-1 (0.1) |
| Example 4 | LiFSI(1) | FSA (3) | Chemical Formula E-1 (0.5) |
| Example 5 | LiFSI(1) | FSA (3) | Chemical Formula E-1 (1.0) |
| Example 6 | LiFSI(1) | FSA (3) | Chemical Formula E-1 (2.0) |
| Example 7 | LiFSI(1) | FSA (3) | Chemical Formula E-1 (2.5) |
| Example 8 | LiFSI(1) | FSA (3) | Chemical Formula E-1 (5.0) |
| Comparative | LiFSI(1) | FSA (3) | — |
| Example 1 | | | |
| Comparative | LiFSI(1) | FSA (3) | Chemical Formula C-1 (1.0) |
| Example 2 | | | |
| Comparative | LiFSI(1) | FSA/Chemical | Chemical Formula C-2 (2.0) |
| Example 3 | | Formula 3-1 | |
| | | (3) | |

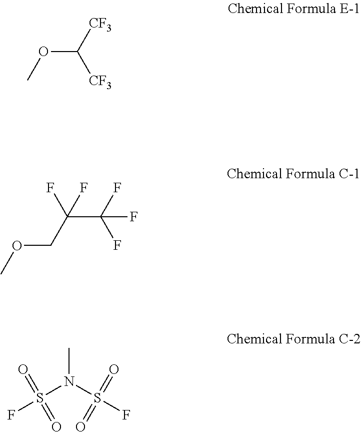

### Experimental Examples

### 1. Li-NCM Electrochemical Evaluation

Li-NCM Durability: Durability and electrochemical characteristics for each electrolyte were evaluated in the same cell structure using a 20 μm-thick lithium thin film as a negative electrode and NCM as a positive electrode.

Li-NCM Electrodeposition Morphology: Lithium electrodeposition morphology on a cross-section and on top was checked by predetermined cycles operating the cells using a 20 μm-thick, thin film lithium as a negative electrode and NCM as a positive electrode and then, charging and disassembling them.

### 2. Raman Solvation Structure Analysis and Nuclear Magnetic Resonance (NMR) Deterioration Trend Quantitative Analysis

Raman Analysis: Analysis was performed under no exposure condition to an external atmosphere by taking 3 mL of each electrolyte sample and using a Raman evaluation kit for liquid samples.

NMR Analysis: A lithium salt consumption trend was quantitatively analyzed by using 500 MHz to quantitatively analyze remaining amounts of lithium salt and a solvent for each cell operation cycle.

### 3. Evaluation of Electrolyte Properties

Ionic Conductivity: Ionic conductivity of each electrolyte manufactured under room temperature conditions was evaluated by using an ionic conductivity meter (mS/cm, at room temperature)

The evaluation results in Experimental Examples 1-3 are shown below.

### Evaluation 1. Evaluation of Lithium Metal Battery Durability According to Additive Type

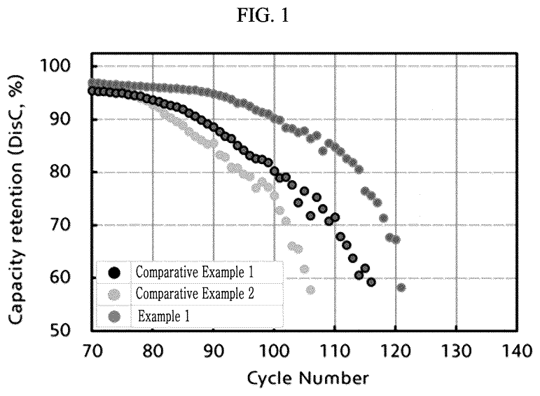

An additive represented by Chemical Formula E-1 was comparatively evaluated by selecting a comparative additive material with a similar molecule structure thereto to verify the effect of improving lithium metal battery durability. Specifically, the additive represented by Chemical Formula E-1 (Example 1) and the additive with a similar molecule structure thereto and represented by Chemical Formula C-1 (Comparative Example 2) were respectively added to the electrolyte according to Comparative Example 1 and then, evaluated with respect to electrochemical characteristics due to their difference, and the results are shown in FIG. 1.

Referring to FIG. 1, unlike the lithium metal battery cell containing the electrolyte according to Comparative Example 1, the lithium metal battery cell containing the electrolyte according to Example 1 was confirmed to exhibit improved durability from the late 80s' cycle. FIG. 1 shows a Capacity Ret. % graph representing a ratio of discharge capacity of each cycle to that of initial cycle, wherein a decrease in discharge capacity at the latter half cycles indicated battery deterioration due to consumption of the lithium salt in the electrolyte, decomposition of the solvent, and the like.

In addition, referring to FIG. 1, the lithium metal battery cell containing the electrolyte according to Comparative Example 2 including the additive with a similar structure to that of Example 1 was confirmed to exhibit rather reduced durability performance, compared with the lithium metal battery cell containing the electrolyte according to Comparative Example 1 as well as the lithium metal battery cell containing the electrolyte according to Example 1. Accordingly, the durability improvement effect of the additive material represented by Chemical Formula E-1 was caused by the fluorinated solvent with a simple asymmetric structure and affected by a type of *—CF₃ functional group with a terminal *—F functional group and the number of F.

Evaluation 2. Durability Evaluation when Including Viscosity-Reducing Agent

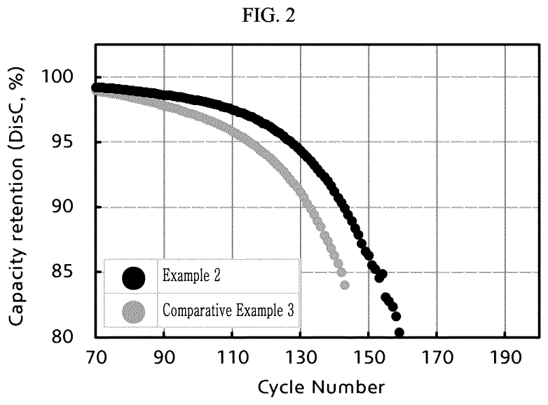

Because an electrolyte for a lithium metal battery developed to date, unlike a general electrolyte for a lithium ion battery, has high viscosity due to a composition in which a high-concentration salt is dissociated, additive development should importantly consider characteristics of an additive for a lithium metal battery in an electrolyte composition including a viscosity-reducing agent in addition to the conventional solvent as well as an electrolyte composition using the conventional solvent alone. Accordingly, an embodiment of the present disclosure was to verify the effect of improving battery characteristics in the composition including the viscosity-reducing agent. In other words, because the viscosity-reducing agent for reducing viscosity of the high-concentration electrolyte was essentially applied, the additive material represented by Chemical Formula E-1 was evaluated with respect to the durability improvement effect as a performance improvement effect in combination with the viscosity-reducing agent, and the results are shown in FIG. 2 (lithium metal battery (coin cell) durability evaluation; ⅓ C durability evaluation using a 20 μm Li thin film).

Referring to FIG. 2, as a result of evaluating durability of the additive represented by Chemical Formula E-1 in an electrolyte composition including an FSA main solvent and a co-solvent represented by Chemical Formula 3-1 (a viscosity-reducing agent), the additive represented by Chemical Formula E-1 exhibited improved durability performance, but the additive material represented by Chemical Formula C-2 exhibited rather reduced durability performance. Accordingly, the durability performance improvement effect was confirmed by the combination of the additive represented by Chemical Formula E-1 and the viscosity-reducing agent represented by Chemical Formula 3-1.

### Evaluation 3. Analysis of Lithium Electrodeposition Morphology of Lithium Metal Battery Cells According to Additive Type

In order to verify a function of the compound represented by Chemical Formula E-1, a film-forming additive, the cells underwent 10 charged and discharged cycles and then, subjected to morphology of lithium electrodeposited on top of the rolled lithium after moving from a positive electrode NCM to a lithium negative electrode by using the same Li-NCM coin cell evaluation tool. In the lithium metal battery (LMB) cells, the electrodeposition of lithium ions moving from the positive electrode onto the negative electrode was a very important factor directly related to LMB durability performance.

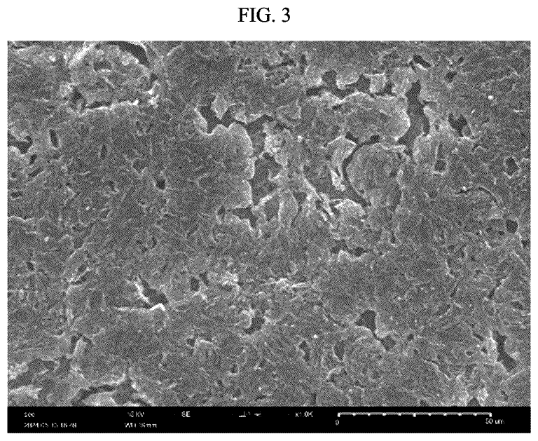

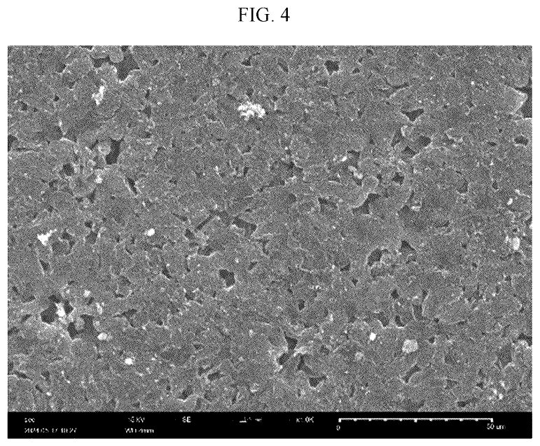

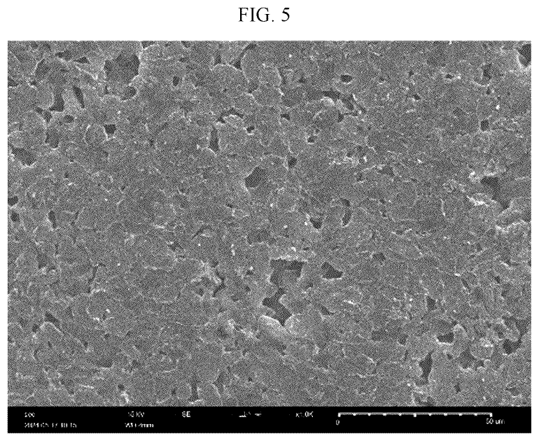

Referring to FIGS. 3-5, when the additive represented by Chemical Formula E-1 and the additive represented by Chemical Formula C-1 were respectively applied, the cells were initially operated with similar performance without particular deterioration phenomenon for each material.

### Evaluation 4. Raman Analysis for Solvation Structure Analysis for Each Electrolyte

Electrolytes have a stable solvation structure resulted from interaction among a lithium salt, a solvent, an additive, and a co-solvent (viscosity-reducing agent) constituting the electrolytes, and the solvation structure affects electrochemical decomposition tendency of each electrolyte component, decomposition products, and stability to electrodes. Accordingly, in order to electrochemical characteristics of batteries, because the solvation structures of electrolytes are very important to understand, it is necessary to verify how application of an additive changes the solvation structures.

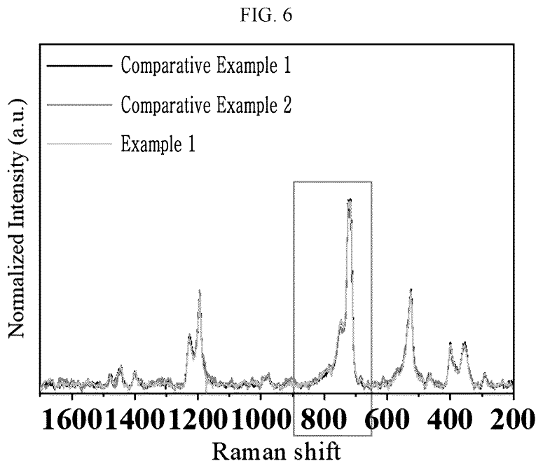

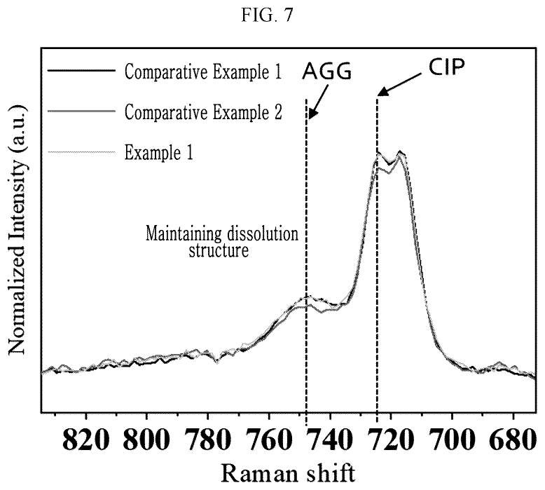

Referring to FIGS. 6 and 7, Example 1, to which the additive represented by Chemical Formula E-1 was applied, and Comparative Example 1, to which the additive was not applied, turned out to have the same solvation structure, which confirmed that the additive represented by Chemical Formula E-1 did not interfere with the unique solvation structure of the electrolyte itself. This also means that the additive did not increase the viscosity of the electrolyte, and when combined with the viscosity-reducing agent, durability performance might be maximized much further.

In addition, referring to FIGS. 6 and 7, comparing the electrolyte solvation structures depending on the presence or absence of the additive represented by Chemical Formula C-1 (Comparative Example 1 vs. Comparative Example 2), intensity of peaks corresponding AGG & CIP around Raman shifts 750 & 725 cm⁻¹ decreased, which exhibited that the solvation structures were changed. The AGG & CIP peaks indicated a bonding state of between Li⁺ and FSI⁻ (Li⁺↔FSI⁻), wherein the higher AGG ratio, the better durability due to generation of LIF (Lithium Fluoride)-based inorganic SEI caused by FSI⁻ (bis(fluorosulfonyl)imide) decomposition. AGG is an abbreviation for Aggregate (or Aggregated ion cluster), and CIP is an abbreviation for Contact Ion Pair. AGG refers to a state in which multiple ions (mainly lithium ions and anions) are collectively bound (a state in which a single Li⁺ ion is bound in a cluster with multiple FSI⁻ ions, or a state in which multiple Li⁺ ions are bound in a cluster with multiple FSI⁻ ions), while CIP refers to a structure in which a lithium ion and an anion come into direct contact to form a pair (a state in which Li⁺ ion and FSI⁻ ion are directly bonded in a 1:1 ratio). In Raman spectroscopy, these two structures are distinguished by different peaks and can be used to quantitatively analyze changes in the dissolution structure.

### Evaluation 5. NMR Analysis for Quantitative Analysis of Lithium Salt Consumption by Each Electrolyte

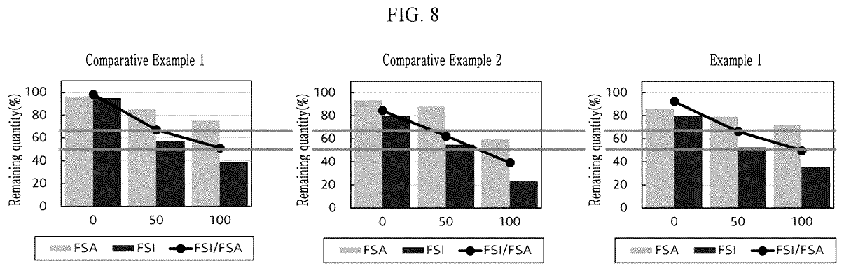

In a system using a lithium metal as a negative electrode and LiFSI-FSA as a lithium salt and a solvent, decomposition and consumption of the lithium salt and the solvent, which are components of an electrolyte, bring about consumption of the electrolyte, which serves as a deterioration factor of lithium metal batteries. The electrolyte consumption may cause a decrease in lithium ionic conductivity by gradually lowering a concentration of the electrolyte, a decrease in output characteristics, and a battery short circuit due to uneven lithium electrodeposition, which resulted in reducing a battery life. Accordingly, in order to evaluate the effect of improving characteristics of lithium metal batteries according to an embodiment, FSI and FSA remaining in an electrolyte after operating the lithium metal batteries were quantitative analyzed by taking the electrolyte, and the results are shown in FIG. 8.

Referring to FIG. 8, as a result of quantitatively analyzing the amounts of FSA and FSI of the electrolyte after the 50^{th} and 100^{th} cycles according to the cell operation for each electrolyte, it was found that each component in Example 1 remained in a greater amount than in Comparative Example 2. In other words, through Comparative Example 2 and Example 1, the improvement effect due to the additive represented by Chemical Formula E-1 was compared and proved, wherein even if the same asymmetric fluorinated solvent structure was used, the battery improvement effect differed depending on the number of *—F functional groups and their branch shape.

### Evaluation 6. Evaluation of Electrochemical Characteristics of Lithium Metal Battery Cells by Amount for Finding Optimal Additive Amount

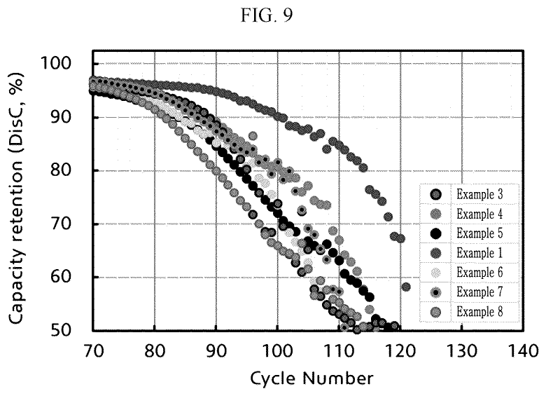

In order to evaluate lithium metal battery characteristics at an optimal amount of the additive represented by Chemical Formula E-1, the lithium metal battery cells were evaluated with respect to durability by adding the additive with the structure in each amount of 0.1 to 5.0 wt %, and the results were provided in FIG. 9 (lithium metal battery durability evaluation; coin cell; ⅓ C durability evaluation using 20 μm thin film Li).

Referring to FIG. 9, when 1.5 wt % of the additive represented by Chemical Formula E-1 was used (Example 1), the battery durability was the most improved but particularly, Examples 6-8, in which greater than 1.5 wt % of the additive was used, exhibited rather no durability improvement. In this way, the difference in the durability improvement effect according to the amounts of the additive was confirmed to be largely caused by the two following factors:
i) Thickness of SEI film: When an SEI film was too thick by the additive, it acted as battery resistance; and
ii) Electrolyte solvation structure: When the additive was too much included, the additive itself changed an inherent solvation structure of the electrolyte, which might limit the film-forming effect.

Accordingly, the fluorinated solvent-based additive represented by Chemical Formula E-1 had an optimal durability improvement effect depending on its amount, and when used in an electrolyte composition with no viscosity-reducing agent, the optimal amount of the additive for improving durability performance was 1.5 wt % based on a total amount of the electrolyte.

### Evaluation 7. Analysis of Electrolyte Ionic Conductivity at Room Temperature

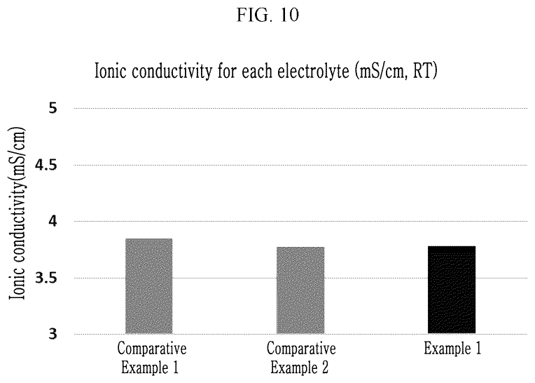

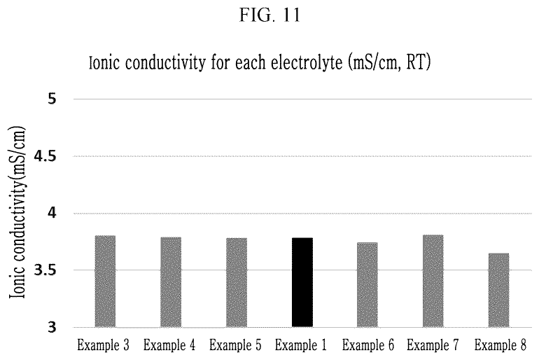

The electrolytes of Examples 1-8 and Comparative Examples 1-3 were analyzed with respect to electrolyte ionic conductivity at room temperature (20° C.), and the results are shown in FIGS. 10 and 11.

Referring to FIGS. 10 and 11, as a result of analyzing ionic conductivity according to types and amounts of the additive, all the electrolytes exhibited similar ionic conductivity of about 3.8 mS/cm, which confirmed that the additive represented by Chemical Formula E-1 simultaneously performed a function of forming a negative electrode film, while maintaining lithium ion transfer characteristics of the electrolytes.

In addition, the electrolyte of Example 1 exhibited a large difference in durability characteristics from the other compositions despite the similar ionic conductivity, which confirmed that the improvement effect due to the additive represented by Chemical Formula E-1 was caused by the negative electrode film-forming effect of the Bulk electrolyte rather than its ion transfer characteristics.

An aspect of the present disclosure provides a lithium metal battery electrolyte with improved electrochemical characteristics by including an additive for forming an asymmetric fluorinated solvent-based negative electrode film. Lithium metal batteries have issues to improve such as lithium growth in the form of dendrite structures, a continuous oxidation-reduction decomposition reaction of electrolyte and electrode, capacity reduction due to irreversible lithium generated during the charge/discharge, and the like. The present disclosure has confirmed that in order to improve durability performance of lithium metal batteries, the additive according to an embodiment may be strategically used to generate a stable film (LIF-based SEI) on a negative electrode and thereby improve electrochemical characteristics, completing the present disclosure.

As aforementioned, conventional arts have only reported that a fluorinated solvent (having an *—F functional group and a symmetric aliphatic chain structure) such as TTE may be used as an electrolyte to improve electrochemical characteristics of lithium metal batteries through an inorganic SEI generation function of the fluorinated solvent. The corresponding arts are significant in that the electrochemical characteristics of lithium metal batteries may be achieved by adding the *—F functional group to an aliphatic chain of a material with an ether functional group to induce generation of an *—F functional group-based SEI and tuning a molecular structure of an additive material itself but only have reported properties of the fluorinated solvent with an aliphatic chain structure symmetrically located at both sides of the ether functional group but yet reported no function of the additive in a fluorinated solvent with an asymmetrical structure to date.

The present disclosure is different from the conventional arts in that a novel fluorinated solvent material with an asymmetric structure was synthesized and applied as an additive to an electrolyte for lithium metal batteries to improve durability and electrochemical characteristics, which has suggested as a new development direction of an additive for lithium metal batteries. In particular, because the additive function of the asymmetric fluorinated solvent has not been applied and verified anywhere in an FSA (dimethylsulfamoyl fluoride) solvent-based electrolyte, which is currently known to be stable as a main solvent for lithium metal batteries, the electrolyte according to an embodiment of the present disclosure and a lithium metal battery including the same may be differentiated from the conventional arts in terms of composition and effect.

More specifically, as examined in the above evaluations, an original molecular structure of an additive material is a major factor that determines reduction and decomposition tendency of the additive for generating inorganic material-based SEI, wherein decomposition tendency and SEI products vary depending on a functional group of additive molecules, which are important for a function of the additive. The present disclosure provides an additive for forming a negative electrode film in an FSA solvent, which has the following three differentiating factors, i.e., a structure of a compound represented by Chemical Formula 1 in order to improve the electrochemical characteristics of lithium metal batteries and explore the improvement effect:
a. Introduction of an *—F functional group for generating LIF;
b. Application of an ether-based asymmetric aliphatic chain structure; and
c. The number of *—F functional groups and Aliphatic chain type.

The electrolyte for lithium metal batteries according to an embodiment of the present disclosure includes an asymmetric fluorinated additive for a fluorinated solvent capable of replacing TTE, which is widely known as a conventional fluorinated solvent for a lithium metal battery, to generate more stable LIF-based inorganic SEI, thereby improving battery durability.

The electrolyte for a lithium metal battery according to an embodiment includes an additive having a specific structure that assists the function of forming a negative electrode film, so that a lithium metal battery including the electrolyte may exhibit very excellent durability performance. In addition, by further including a viscosity-reducing agent having a specific structure as a non-aqueous organic solvent in the electrolyte, durability performance of a lithium metal battery including the same may be maximized or improved.

Although embodiments of the present disclosure have been described above, the present disclosure is not limited thereto, and various modifications may be made within the scope of the patent claims, the detailed description of the present disclosure, and the attached drawings, which also fall within the scope of the present disclosure.

Accordingly, the substantial scope of the present disclosure is defined by the appended claims and their equivalents.

What is claimed is:

1. An electrolyte for a lithium metal battery, the electrolyte comprising:
a lithium salt;
a non-aqueous organic solvent; and
an additive including a compound represented by Chemical Formula 1: 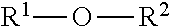
wherein, in Chemical Formula 1,
R¹ is a substituted or unsubstituted C1 to C20 alkyl group, R² is represented by Chemical Formula 2: 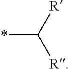
wherein, in Chemical Formula 2,
R′ and R″ are each independently a substituted or unsubstituted C1 to C20 alkyl group,
* represents a moiety linked to one or more same or different atoms or chemical formulas, and
R¹ and R² are different from each other.

2. The electrolyte of claim 1, wherein
R¹ is an unsubstituted C1 to C10 alkyl group.

3. The electrolyte of claim 1, wherein
the non-aqueous organic solvent comprises N,N-dimethylsulfamoyl fluoride.

4. The electrolyte of claim 3, wherein
the non-aqueous organic solvent further comprises a viscosity-reducing agent.

5. The electrolyte of claim 4, wherein
the viscosity-reducing agent comprises a compound represented by Chemical Formula 3: 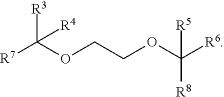
wherein, in Chemical Formula 3,
R³ to R⁶ are each independently a halogen group, and
R⁷ and R⁸ are each independently a C1 to C20 alkyl group substituted or unsubstituted with one or more halogen groups.

6. The electrolyte of claim 4, wherein
the additive comprising the compound represented by Chemical Formula 1 is included in an amount of 1.5 wt % to 2.0 wt % based on a total amount (100 wt %) of the electrolyte for the lithium metal battery.

7. The electrolyte of claim 1, wherein
the additive comprising the compound represented by Chemical Formula 1 is included in an amount of greater than 1.0 wt % and less than or equal to 2.0 wt % based on a total amount (100 wt %) of the electrolyte for the lithium metal battery.

8. The electrolyte of claim 1, wherein
the lithium salt comprises at least one of lithium bis(fluorosulfonyl)imide (LiFSI), lithium (fluorosulfonyl)(nonafluorobutanesulfonyl)imide (LiFNFSI), or lithium bis(trifluoromethanesulfonyl)imide (LiTFSI).

9. The electrolyte of claim 1, wherein
a concentration of the lithium salt is in a range of 1.0 M to 4.0 M.

10. A lithium metal battery, comprising
a positive electrode;
a lithium metal layer as a negative electrode facing the positive electrode;
a separator interposed between the positive electrode and the negative electrode; and
an electrolyte for the lithium metal battery,
wherein the electrolyte comprises
a lithium salt,
a non-aqueous organic solvent, and
an additive including a compound represented by Chemical Formula 1: 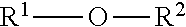
wherein, in Chemical Formula 1,
R¹ is a substituted or unsubstituted C1 to C20 alkyl group,
R² is represented by Chemical Formula 2: 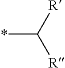
wherein, in Chemical Formula 2,
R′ and R″ are each independently a substituted or unsubstituted C1 to C20 alkyl group,
* represents a moiety linked to one or more same or different atoms or chemical formulas, and
R¹ and R² are different from each other.

11. The lithium metal battery of claim 10, wherein
the lithium metal layer is formed to have a thickness in a range of 5 μm to 50 μm.

12. The lithium metal battery of claim 10, wherein
the positive electrode comprises lithium-nickel-manganese-cobalt-based metal oxide.

13. The electrolyte of claim 10, wherein
R¹ is an unsubstituted C1 to C10 alkyl group.

14. The electrolyte of claim 10, wherein
the non-aqueous organic solvent comprises N,N-dimethylsulfamoyl fluoride.

15. The electrolyte of claim 14, wherein
the non-aqueous organic solvent further comprises a viscosity-reducing agent.

16. The electrolyte of claim 15, wherein
the viscosity-reducing agent comprises a compound represented by Chemical Formula 3: 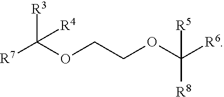
wherein, in Chemical Formula 3,
R³ to R⁶ are each independently a halogen group, and
R⁷ and R⁸ are each independently a C1 to C20 alkyl group substituted or unsubstituted with one or more halogen groups.

17. The electrolyte of claim 15, wherein
the additive comprising the compound represented by Chemical Formula 1 is included in an amount of 1.5 wt % to 2.0 wt % based on a total amount (100 wt %) of the electrolyte for the lithium metal battery.

18. The electrolyte of claim 10, wherein
the additive comprising the compound represented by Chemical Formula 1 is included in an amount of greater than 1.0 wt % and less than or equal to 2.0 wt % based on a total amount (100 wt %) of the electrolyte for the lithium metal battery.

19. The electrolyte of claim 10, wherein
the lithium salt comprises at least one of lithium bis(fluorosulfonyl)imide (LiFSI), lithium (fluorosulfonyl)(nonafluorobutanesulfonyl)imide (LiFNFSI), or lithium bis(trifluoromethanesulfonyl)imide (LiTFSI).

20. The electrolyte of claim 10, wherein
a concentration of the lithium salt is in a range of 1.0 M to 4.0 M.
